(19) United States
(12) Patent Application Publication
(10) Pub. No.: US 2001/0030309 A1
(43) Pub. Date: Oct. 18, 2001

(54) Control valve with modified characteristics

(76) Inventors: Bengt A. Carlson, Stamford, CT (US); Werner A. Buck, Ridgefield, CT (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 09/778,356

(22) Filed: Feb. 7, 2001

Related U.S. Application Data
(63) Continuation of application No. 09/219,917, filed on Dec. 23, 1998, now abandoned.

(51) Int. Cl. F16K 5/10

(52) U.S. Cl. 251/209; 137/269

(57) ABSTRACT

A control valve is provided for controlling fluid flow in industrial systems, such as heating, ventilating and air conditioning systems, having a fluid flow passageway with a cross-sectional shape of an opening such that the fluid flow increases exponentially as valve ball or plug, and is opened and which is relatively simple to manufacturer.

### PRIOR APPLICATION

There is a prior application by the same inventor bearing Ser. No. 091084,698 and filed on May 26, 1998 in the United States Patent Office.

### FIELD OF THE INVENTION

The invention relates to controls valves, and in particular, ball valves and plug cock valves for controlling fluid flow in industrial processes, especially those used in heating or cooling coils in heating, ventilation and air conditioning (HVAC) systems.

### BACKGROUND

Ball valves and plug cock valves are valves which have a movable member (i.e., ball or plug) rotatable, usually 90°, about the movable member's central access to open or close them. Thus, they are generally known as “quarter tum” valves. These valves can be used to control the fluid flow in pipes and in particular in heating, ventilating and air conditioning (HVAC) applications. The ball or plug has a hole that cooperates with a portion of the adjacent valve casing or seat area as the ball or plug is rotated to define a port or fluid flow passageway having an effective cross-section area through which fluid passes.

The relationship between the cross-sectional area of the valve relative to the degree of opening is known as the “valve characteristics”. It is understood that flow characteristics relate to how we operate the valve. The valve characteristics are influenced by the cross-sectional shape of the fluid flow passageway or effective cross-sectional. An equal change in fluid flow (as a percentage) over the previous flow for each change in the degree of opening of the valve or in shaft rotation is known as “equal percent characteristics”, and is generally desired. For example, if opening the valve by an additional 10% causes a 10% increase in fluid flow, the valve exhibits equal percent characteristics. A valve with equal percent characteristics increases the fluid flow at a very low rate when the valve first begins to open and then as the degree of opening is increased, the rate of increase in fluid flow increases. It is understood by those skilled in the art that equal percent characteristics are theoretical and a goal for value design

There are a number of different theoretical equations for approximating valve characteristics, but they all display the same general characteristics in that the fluid flow is increased at a very low rate when the valve first begins to open and then as the degree of opening is increased, the rate of increase in the fluid flow increases. In addition, many of these valve theoretical equations do not reach zero at the completely closed position of the valve. Usually the curve is modified near the closed position so the flow is zero when the valve is closed. It should be noted, however, that throughout this application, the equal percent characteristics in a valve is mentioned and described for illustrative purposes only and is not intended to be limiting. For example, all valve characteristics that require a dramatic increase near the fully open position, whether or not equal percent, are covered by this patent application.

U.S. Pat. No. 4,130,580 to Norris et al. describes modifying a plug valve to provide a plug with elliptical opposing ends and relatively linear portions between those ends and a similarly shaped opening in the plug so as to approximate the operation of a ball valve.

In an earlier invention, U.S. patent application Ser. No. 09/084,698, the disclosure of which is incorporated herein by reference, describes a ball or plug valve is described, which is comprised of two pieces and a disk disposed in the seat area having a V-shaped opening with substantially straight side portions, thereby modifying the cross-sectional shape of the port or fluid flow passageway, without unduly increasing the complexity of manufacture or assembly of the valve. As the ball or plug is turned to open the valve, the pointed narrow end of the V-shaped opening is first exposed to the fluid flow. The opposite end from the apex, or the wide end, is exposed to the fluid flow last, as the valve ball or plug approaches its fully-opened position. It should be noted that generally the larger the cross-sectional area of the passageway the greater the flow will be, and the smaller the resistance to flow will be.

The valve with the inventive V-shaped opening in the disk described immediately above exhibits valve characteristics which approximate modified equal percent characteristics up to a certain degree of opening, but, as the valve is opened further, the rate of increase in cross-sectional area, and therefore fluid flow, will not be sufficiently steep so as to achieve equal percent characteristics as the valve approaches the fully opened position. It has now been discovered that a conventional V-shaped valve as described in U.S. patent application Ser. No. 09/084,698 tends not to be able to provide the required desired dramatic increase near the fully opened position, especially not when ball valves are used, because the cooperation between the hole of the ball and the seat area is such that the effective cross-sectional area of the port or fluid flow passageway does not increase sufficiently at the end of the movement of the ball.

Common disadvantages of conventional valves are that they tend not to provide the desired increase as the valve is fully opened, to have a very small effective operating range, or not to be able to provide stable control over the entire operating range. Accordingly, a disadvantage of HVAC systems having conventional flow control valves for the heating or cooling coil is that heating or cooling output is unstable and difficult to control as a function of the valve position.

What is desired therefore is a control valve that is relatively simple to manufacture and assemble, and that provides a fluid flow that increases very little as the valve begins to open and then dramatically as the valve is fully opened, and more particularly, a method for providing relatively linear heating or cooling output of a system by controlling the position of a ball or plug valve.

### SUMMARY OF THE INVENTION

Accordingly, it is an object of the invention to provide a control valve which provides responsive and stable fluid flow control through a coil or pipe and which is relatively simple to manufacture and assemble.

Another object of the invention is to provide a control valve that provides a high rate of increase in the cross-sectional area of the fluid flow passageway as the valve approaches its fully opened position.

A further object of the invention is to provide a control valve which approaches an approximately equal percentage change in fluid flow from the previous flow for equal incremental shaft movements, over most of the entire range of shaft movements.

Yet another object of the invention is to provide relatively linear heating or cooling output relative to valve position.

These and other objects are achieved by provision of a device for controlling fluid flow in a pipe having a generally curved perimeter and being positioned substantially transverse to the fluid flow in said pipe, a valve having a casing defining a valve chamber for controlling fluid flow through a fluid flow passageway, a method for controlling heating or cooling output of a system or a valve having a shaft for controlling the position of the valve relative to its opened and closed positions and a valve having a valve characteristic which produces an approximately equal percent flow characteristic. More particularly, these objects are achieved by provision of upper and lower portions extending from an apex adjacent to the perimeter and terminating in a flared shape to define an opening for allowing fluid to flow therethrough, operating a valve having a valve casing and a device which is integral with the valve casing comprising upper and lower portions extending from an apex adjacent to the perimeter and terminating in a flared shape to define an opening for allowing fluid to flow therethrough, and at least one device positioned transverse to the direction of fluid flow and having an opening with a cross-sectional area which approximates e^{a} (h/100−1), where a is between about 2 and about 5, and h is the valve shaft position, but modified so that the cross-sectional area is zero, when h is zero.

The invention and its particular features will become more apparent from the following detailed description considered with reference to the accompanying drawings.

### BRIEF DESCRIPTION OF THE DRAWINGS

FIG. 1 is plan view of a disk 100 in accordance with the invention showing the valve 10 and port 60 in phantom.

FIG. 1A is an elevation view of the disk 100 of FIG. 1 taken in the direction of 1A-1A.

FIG. 2 is a cross-sectional view of the disk 100 of FIG. 1 taken along section line 2-2.

FIG. 3 is plan view of another embodiment of the disk 100″ in accordance with the invention.

FIG. 4 is a section view of a valve 10 having the disk 100 in accordance with the invention.

FIG. 5 is a plan view of a ball 30′ and shaft 20′ in accordance with the invention.

FIG. 6 is a cross-sectional view of the ball 30′ of FIG. 5 taken along section line 6-6.

FIG. 7 is a graph showing the desired valve 10 characteristic (EQ).

FIG. 8 is a graph showing the measured valve characteristic curve (measured curve) using the disk 100 in accordance with the present invention as compared to an approximately equal percent curve (EQM).

FIG. 9 is a plan view of another embodiment of a disk 100″ in accordance with the present invention.

FIG. 10 is a section view of the disk 100″ of FIG. 9 taken along section line 10-10.

FIG. 11 is a section view of the disk 100″ of FIG. 9 taken along section line 11-11.

FIGS. 12-16 depict the effective cross-section area resulting from the communication between the disk 100 of FIG. 1 and the port 70 as the disk 100 is in its fully closed position (FIG. 12) and its fully opened position (FIG. 16).

FIG. 17 shows fluid flow relative to valve characteristic.

### DETAILED DESCRIPTION OF THE INVENTION

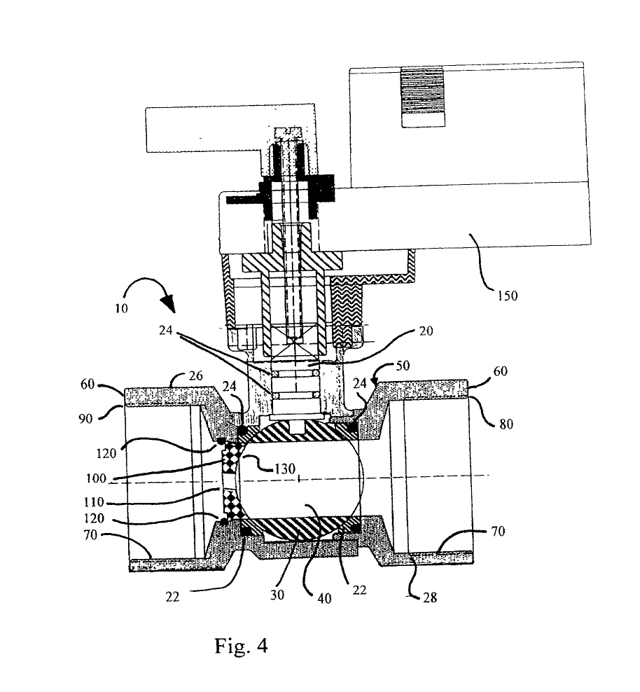

FIG. 4 depicts a valve 10 in accordance with the present invention having a movable member 20, which can be a plug or ball 30, having a hole 40, and rotatable 90° or a quarter turn, and having a casing 50 comprised of main body 26 and a screw in body 28 to form a two-piece valve 10. The casing 50 has connection ports 80 and 90 and defines a valve chamber 70 with a seat 22 for receiving a ball or plug 30. It is understood that a shoe valve may be used having a shoe as a movable member, and would be known to those skilled in the art. As used herein, “upstream port” 80 is the end of the valve 10 having higher pressure (i.e., represents the direction from which fluid is flowing), relative to the direction of fluid flow as shown by the arrow in FIG. 4. “Downstream port” 90 is the end of the valve 10 having the lower pressure (i.e., represents the direction to which fluid is flowing), as understood by those skilled in the art.

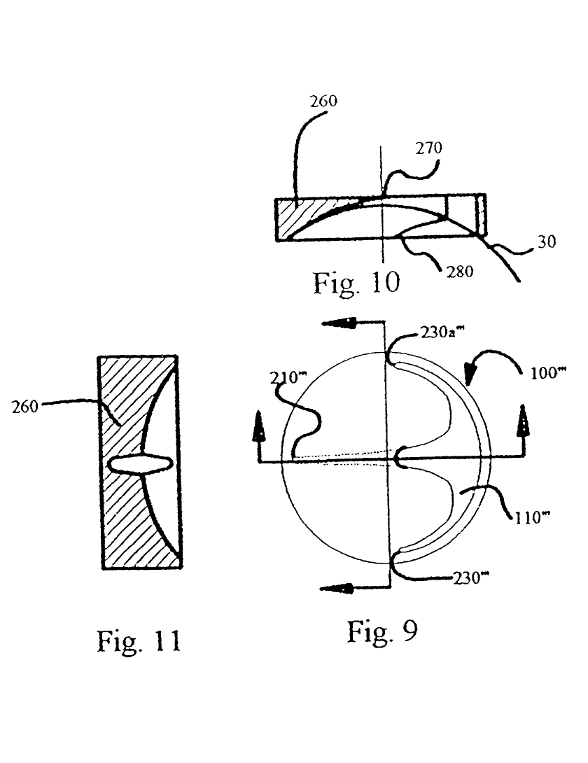

In one embodiment, the valve 10 is modified slightly to retain a disk 100 which has a specially-shaped opening 110, as shown in FIGS. 14 and 9-12. The disk 100 is inserted into one of the connection ports 80 and 90, usually the downstream port 90, of the valve 10 adjacent to the ball or plug 30. Typically, disk 100 is fastened by a retaining ring 120 or similar device known by those skilled in the art. O-rings 24 are typically used adjacent to the shaft 20 and seat 22 to prevent fluid from leaking around the shaft 20. A groove is preferably provided in the seat 22 to receive the retaining ring 120. The reverse flow direction is also possible.

The disk 100 is preferably provided with a key, and valve chamber 70 is provided with a corresponding recess to fix the position of opening 110 relative to hole 40 in ball or plug 30. It is of course possible that instead the disk may be provided with a recess and the valve chamber 70 with the key. It is also possible to use no recess and key and just mount the disk 100 positioned correctly, however.

When assembled together as shown in FIG. 4, main body 26 and screw-in body 28 form the casing 50 which has ports 80 and 90 for connection to a pipe and a heating or cooling system, and valve chamber 70. The valve chamber 70 contains the ball or plug 30 and the seat 22 and disk 100, if used.

In typical operation, valve 10 is automatically controlled by actuator 150 connected to a thermostat. In this way, heating or cooling output is controlled by varying fluid flow through the heating or cooling coil. Actuator 150 controls the rotation of the ball or plug 30 by rotating the shaft 20. Using valve 10, enables the use of a relatively simple actuator 150 without a process control algorithm or with a relatively simple algorithm embedded in it since valve 10 has an effective cross-sectional area 300 such that linear or stable control of fluid flow are achieved.

Surface 130 of the disk 100 that faces the ball 30 advantageously is concave and substantially corresponds to the spherical surface of the ball or plug 30 inside the valve 10. The disk 100 is preferably mounted with its concave surface 130 resting on or, more preferably, very close to the ball or plug 30. Preferably, a space between the disk 100 and ball or plug 30 is left so as to minimize fluid from flowing between the disk 100 and the ball or plug 30 (i.e., by-pass flow) yet so as to avoid interference of the disk 100 with the ball or plug 30 and to allow smooth operation of the valve 10. Most preferably, the space ranges from about 0.0005 to 0.0015 inches, and more preferably is about 0.001 inches.

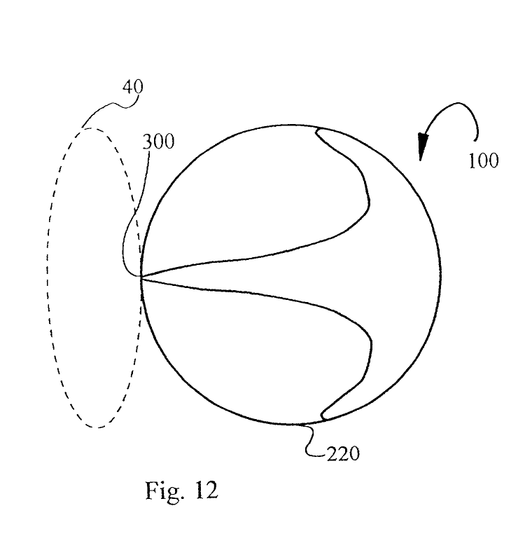

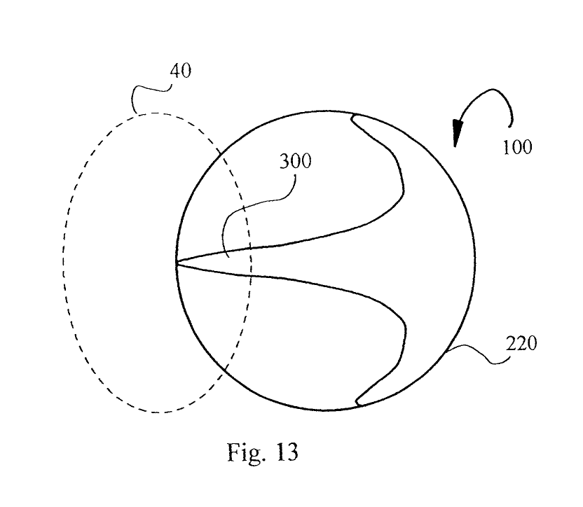

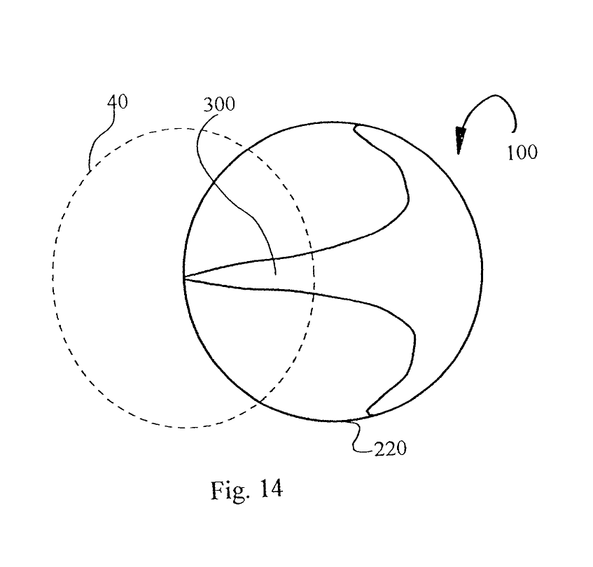

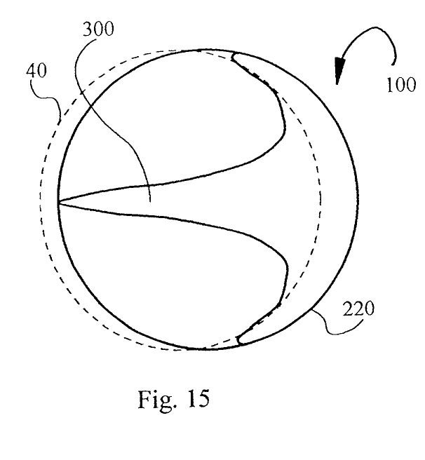

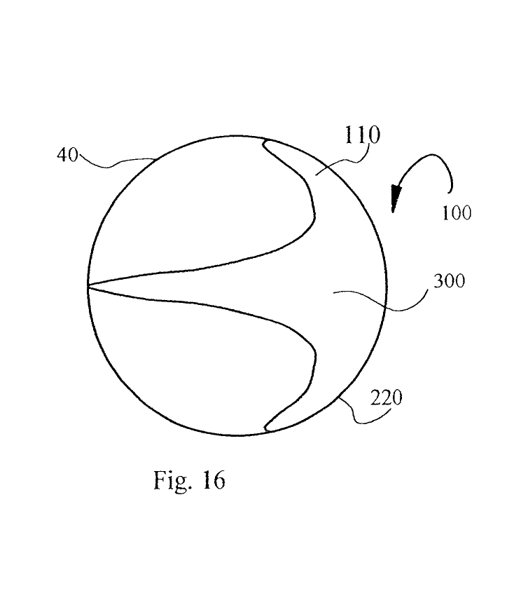

The invention provides the desired flow coefficient, CV, or fluid flow relative to shaft movements. The desired fluid flow is achieved by providing an effective cross-sectional area 300, as shown in FIGS. 12-16. It is understood that the “effective cross-sectional area” 300 means the cross-sectional area of the fluid flow passageway resulting from the communication between the hole 40 of the ball or plug 30, and the opening 110 of the disk 110, or the hole 40 of the ball or plug 30 and the specially shaped valve chamber, or the hole 40′ of the ball or plug 30′ having the specially shaped opening 110′ or contoured body 160 and the valve chamber. Thus, the desired flow coefficient and effective cross-sectional area 300 is achieved by the provision of disk 100, ball or plug 30′ or contoured body 160 or valve chamber having a specially shaped opening.

It is now been discovered that a given valve needs to have a certain effective cross-sectional area 300, or flow capacity, when it is fully open to provide the desired fluid flow in the given application. At the same time, the equal percent characteristics dictate that the effective cross-sectional area 300 shall increase very slowly as the valve begins to open. This means that only a relatively small effective area is exposed to fluid flow although the valve may be, for example, be 60% open, and the major portion of the valve cross-sectional area remains unexposed to fluid flow. Therefore, the opening 110 needs to increase dramatically (i.e., exponentially) as the valve 10 is opened the remaining 40%. Thus, valves 10 must be further modified to provide an escalating rate of increase in the effective cross-sectional area 300 as the valve 10 approaches the fully opened position, yet which are relatively simple to manufacture and assemble.

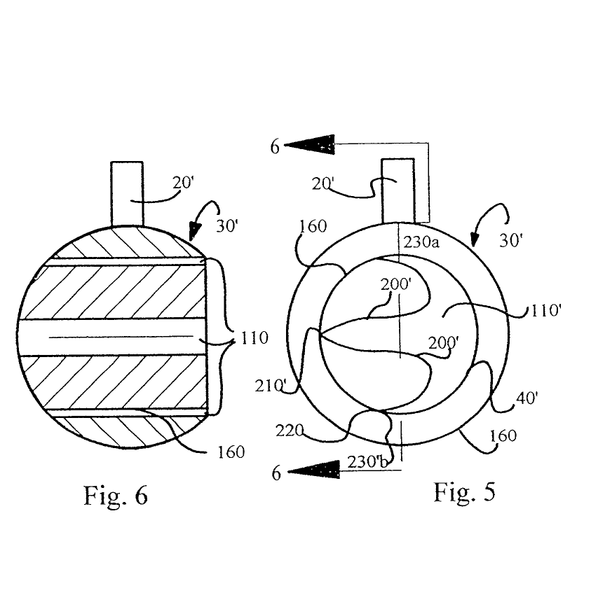

The desired modified flow characteristics may be provided by a valve 10 having a disk 100 with a specially shaped opening 110 as described above, by a valve 10 having a valve chamber having a specially shaped opening (not shown) which cooperates with the hole 40 of the ball or plug 30 and no disk 100, or by valve 10 having a ball or plug 30′ with a specially shaped opening 110′. The ball or plug 30′ which has a specially shaped opening 110′ is shown in FIGS. 5 and 6. The specially shaped opening 110′ may be provided by forming the ball or plug 30′ from a single piece of material with the opening 110′ having the desired shape. Alternatively, a contoured body 160 may be provided as a separate piece and inserted into the hole 40 of a standard ball or plug 30 so as to provide a ball or plug 30 having a specially shaped opening 110′. In this manner, the effective cross sectional area 300 of the fluid flow passageway is modified so as to provide the desired flow characteristics.

For example, where a disk 100 is used, the disk 100 communicates with the hole 40 of the ball or plug 30 in a way such that the desired flow coefficient, CV, and, accordingly, fluid flow, typically in gallons per minute, are achieved as the ball or plug 30 is turned between the closed and opened position, as shown in FIGS. 12-16. Where the valve chamber has the slightly modified opening and no disk 100, the effective cross-sectional area 300 of the fluid flow passageway is that resulting from the communication between the modified opening of the valve chamber and the hole 40 of the plug or ball 30. Where the plug or ball 30′ has a modified opening 110′, the effective cross-sectional area 300 is that resulting from the communication between the modified opening 110′ of the ball or plug 30′ or contoured body 160 and the valve chamber 70.

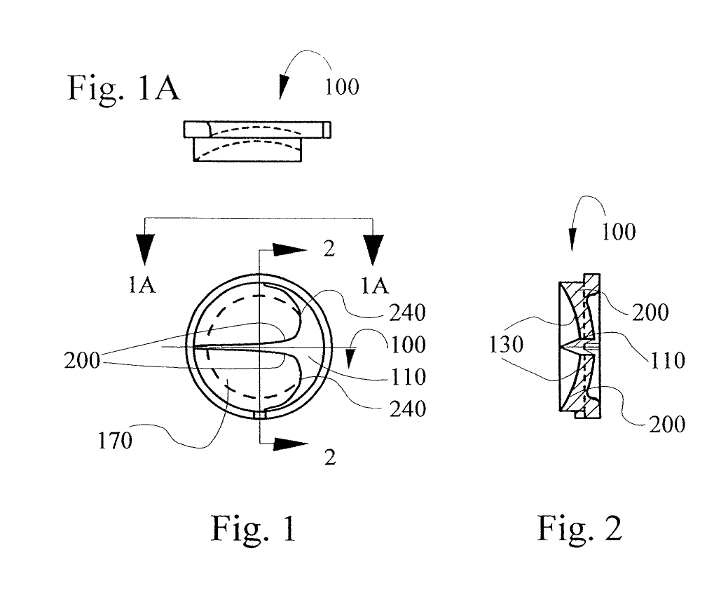

As shown in FIG. 1, the control valve 10 may have a slightly reduced sized port 170. In valve 10 having a reduced sized port 170, the largest diameter of the hole 40 of the ball or plug 30 is slightly smaller than the largest diameter of the port 170 or valve seat 22 in the valve chamber 70. The reduced size port 170 eliminates the risk of the disk 100 moving into the hole 40 when the valve 10 is fully opened.

The surface 130 of the disk 100 facing the ball or plug 30 may be cantered slightly, as disclosed in our earlier U.S. patent application Ser. No. 09/084,698. By “cantered”, it is meant that one side of the disk 100 is thicker than the opposed side. A cantered disk 100 enables the use of a full port 60 without risk that the disk 100 will interfere with the ball or plug 30.

As shown in FIGS. 1-3, 5-6, and 9-16, the cross-sectional area of openings 110, 110′, 110″ have a generally symmetrical shape about the horizontal central axis. The openings 110, 110′, and 110″ have upper and lower portions 200 converging with each other to define an apex or pointed end 210. Upper and lower sides extend from the apex in a generally curved shape similar to the shape of a cross-section of a trumpet or bell taken along a section line draw in the longitudinal direction of the trumpet or bell. Portions 200 terminate at ends 230a and 230b at the perimeter 220 of the valve chamber 70. Thus, portions 200 have an outward flared shape. This shape helps to provide an effective cross-sectional area 300 that increases exponentially or escalates as valve 10 approaches its fully opened position, and accordingly approximately equal percent characteristics. It is understood that as long as the cross-sectional area of opening 110, 110′, 110″ increases in a greater than linear fashion, or preferably exponentially, as the valve approaches its fully opened position, any shaped opening 110, 110′, 110 ″ may be used be it holes or other multiple openings.

It is now recognized that the escalation in the effective cross-sectional area 300 as the valve 10 approaches its fully opened position enables good valve 10 responsiveness and stable system control. Thus, it may now be possible to provide valves having openings with other shapes having similar benefits, yet somewhat different designs. For example, a design which is asymmetrical may provide benefits similar to the symmetrical shape described above, as long as the cross-sectional area of opening increases exponentially as the valve 10 approaches its fully opened position.

It is preferred that the generally curved portions 200 are not only flared outward but also back toward apex 210 terminating at ends 230a and 230b on perimeter 220 of the chamber 70. Ends 230a and 230b are preferably closer to a vertical line drawn through apex 210 than point of inflection 240 is relative to the same vertical line drawn through apex 210. This even further improves the rate of cross-sectional area as the valve 10 is opened. The ends 230 preferably flare outward to the extent that they overlap with the generally curved portions 200 and extend back toward the apex 210. Upper and lower portions 200 generally curve upward beginning at the apex 210 with increasing curvature the greater the distance from apex 210. As the distance from apex 210 is increased, the curvature of the upper and lower portions 200 eventually becomes orthogonal to a horizontal axis intersecting apex 210, before upper and lower portions 200 terminate at ends 230a and 230b on perimeter 220 to define a point of inflection 240 on each portion 200. At point of inflection 240, upper and lower portions 200 bend back on themselves and terminate at ends 230a and 230b at perimeter 220 of valve chamber 70. Typically, upper and lower portions 200 may be symmetrical or mirror images of each other, however, asymmetry is also possible so long as the desired increase in effective cross-sectional area 300 as the valve 10 reaches its fully opened position is achieved.

Valve 10 having the characteristics described above is typically installed in a pipe so that apex or pointed end 210 is oriented to the left approximately at the 9 o'clock position when facing the valve 10 with the shaft 20 vertically oriented transverse to the direction of the fluid flow as shown in FIGS. 1, 5 and 6. Installed properly, apex 210 is first exposed to the fluid as the valve 10 is opened, and point of inflection 240 is the last.

Disk 100 is preferred because it tends to be relatively simple to manufacture and assemble. Disk 100 is preferably installed in the upstream port 80, but may also be installed at the downstream port 90 of the valve 10. It is also understood that a disk 100 may be used in each port 80, 90 if desired.

It is understood that the valves 10 contemplated by this invention include so-called two-way valves, which have two ports 80 and 90 for pipe connections, and so-called three-way values, which have three ports for pipe connections. Three-way valves preferably utilize two disks 100. The disks 100 preferably located at ports 80 and 90.

Three-way valves can be piped for mixing where the fluid flow (typically water) enters two ports and exits through a common port, or for diverting where the fluid flow enters the common port and exits the two controlled ports. The common port is always open while the flow resistance through the controlled ports is determined by the moveable member. When one of the controlled ports is open, the other controlled port is closed. As the first port begins to close, the other port begins to open. Other valves, such as shoe valves, are also contemplated by this invention. For simplicity, the following text refers to two-way valves, but what is said also is applicable to the controlled ports of 3-way valves.

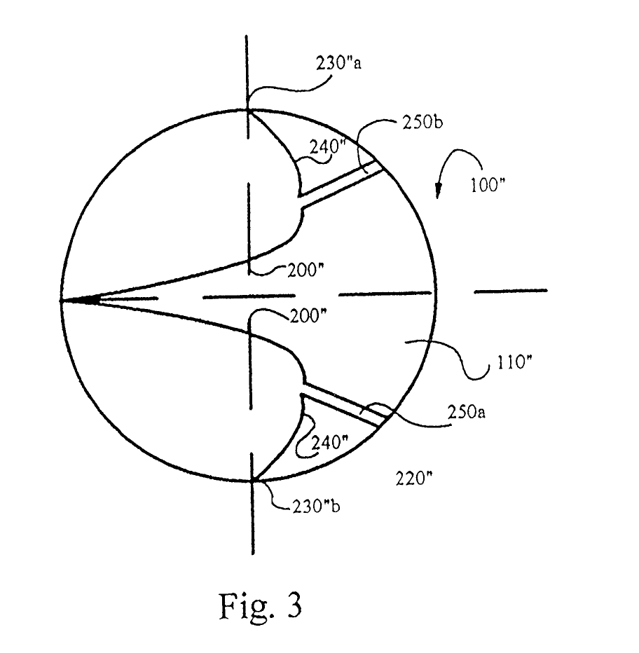

Of course, it is possible to make variations of the above-described shape of opening 110 and 110′. For example, as shown in FIG. 3, a disk 100″ is provided having opening 110″ which is divided into different parts by a relatively thin support bars 250a and 250b, which connects an intermediate point on upper and lower portions 200″ to perimeter 220 of valve chamber 70″ in which disk 100″ is mounted. Support bar, 250a and 250b provide support for ends 230a″ and 230b″ of the flared portions 200″ adjacent to point of inflection 240″ and therefore durability. It is understood that any other means known to those skilled in the art may provide suitable support and durability.

FIG. 5 depicts a plan view of a ball 30′ having an apex 210′ and symmetrical upper and lower portions 200′ which are generally curved, and shaft 20′. FIG. 6 shows a section view of ball 30 of FIG. 5 at section line 6-6 further illustrating opening 110′. Ball 30′ may be machined from a single piece of material thereby providing opening 110′. Preferably a contoured body 160 having at least one substantially planar side is inserted into the hole 40 in the ball 30 so that the substantially planar side is transverse to the direction of fluid flow. The contoured body 160 reduces the cross-sectional area of hole 40 of the ball 30, and allows for a standard ball 30 to be used. At least one side of contoured body 160 preferably has a convex shape similar to the shape of the ball or plug 30 in which is it disposed. The contoured body 160 preferably has the specially-shaped opening 110′ as described above. It is understood that using a contoured body 160 integral with the ball or plug 30 may require providing the contoured body 160 with an annular ring and retaining ring (not shown).

Disks 100, 100′ and 100″ for very small flows tend to have very narrow openings 110, 110′, 110″ especially at apex 210, 210′ and 210″. There is a risk therefore, that dirt, particles or other contaminants accumulate at upstream port 80 of valve 10 and interfere with the valve operation. As shown in FIGS. 9-11, a cover or “tent” 260 may be disposed over apex 210′″ leaving flared ends 230a′″ and 230b′″ uncovered. Cover 260 prevents the fluid flow from flowing directly from one side 270 of the disk 100′″ to the opposite side 280. Instead, the fluid has to move sideways to find the portion of the opening 110′″ that is not covered. The fluid has to flow a relatively long way before it passes the disk 100′″. Thus, cover 260 enables the use of a larger opening 110′″ near apex 210′″ while maintaining the desired flow characteristics. Accordingly the larger the opening 110′″ adjacent to the apex 210′″, the easier it will be for particles to pass. Cover 260 therefore maintains the desired flow characteristics while minimizing particle accumulation.

FIG. 9 depicts a disk 100′″ with the concave surface facing away. Flared ends 230a′″ and 230b′″ are uncovered while apex 210′″ has cover 260. FIG. 11 shows a cross-sectional view of cover 260 having a gulley 300 which extends from midway down flared ends 230′″ to apex 210′″. FIG. 10 shows a cross-sectional view of cover 260 adjacent to the apex 210′″ and opened or uncovered at the flared ends 230′″, and ball or plug 30 in phantom. It can be seen in FIG. 10 that gulley 300 has a concave shape extending away from ball or plug 30 or, depending from gulley 300 as gulley 300 approaches the flared ends 230a′″ and 230b′″, and apex 210′″ curves down to the concave surface of the ball or plug 30. There is a direct communication between the two sides 270 and 280 near the flared ends 230′″. It is understood that cover 260 may be integral with or a separate piece attached to a disk 100′″ having the desired opening 110′″.

It is understood that all valves 10, plugs or balls 30, 30′, disks 100, 100′, 100″, and 100′″, contoured bodies 160 and other components described herein may be made using any suitable metal such as copper, brass or steel or other alloy or suitable plastic or rubber, or composites thereof depending upon the application, which is well-known to those skilled in the art. A molded synthetic resinous fluorine-containing polymer, known as TEFZAL®, available from I.E. DuPont De Nemours and Company, Wilmington, Del., is preferred for the disk 100, 100′, 100″, 100′″. The valve seat is preferably polyfluoroethylene.

The control valves control the fluid flow to heat transfer devices. A coil or other heat transfer device is connected to one of the ports 80 or 90 of the valve 10. The other port is 90 or 80 connected to a pipe that bypasses the heat transfer device. By controlling valve shaft 20 using actuator 150, as shown in FIG. 4, the heating or cooling output through the system is controlled. The heat transfer devices typically have a non-linear heat transfer characteristics with respect to the fluid flow. For example, heat output increases very rapidly when the fluid flow first begins to increase using conventional valves. However, as the flow is increased, the rate of increase of the heat output declines. Compared to a linear curve, the heat transfer characteristics curve resides above the curve representing linear or proportion control of heat output, and can be said to be convex.

For stable control of heat output it is desirable to have a linear relationship between the position of the moveable member and the heating or cooling output, and is provided by valve 10. This will result in favorable operating conditions for the temperature control system and a more stable control of the temperature. In order to accomplish this, the valve 10 needs to control the flow with respect to the position of the moveable member in a non-linear fashion that is complementary with the non-linear heat transfer characteristics curve of the heat transfer device so as to provide a resultant heating or cooling output curve which is linear.

Different heat transfer devices have heat transfer characteristics curves with more or less pronounced curvature. It is impractical to select valves with characteristics that are perfect for each individual heat transfer device. Instead valves are usually designed with a valve characteristic that is suitable for an average heating coil.

As discussed above, the valve 10 having so-called “equal percent” valve characteristics is the goal. A valve 10 with equal percent characteristics increases the fluid flow at a very low rate when first begins to open and then, as a degree of opening is increased, the rate of increase in fluid flow gradually increases in a controlled manner.

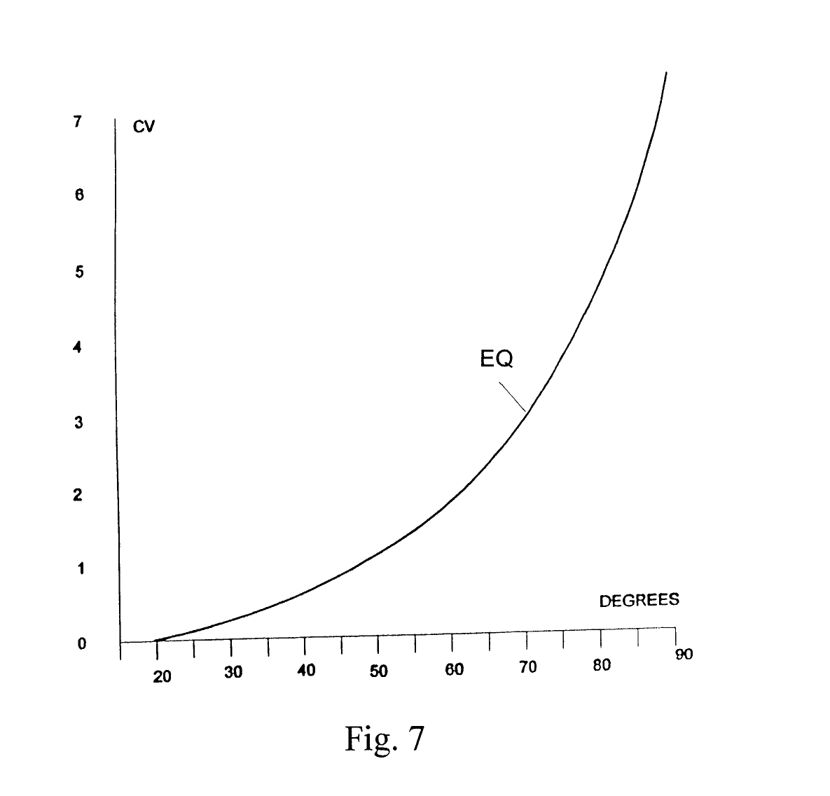

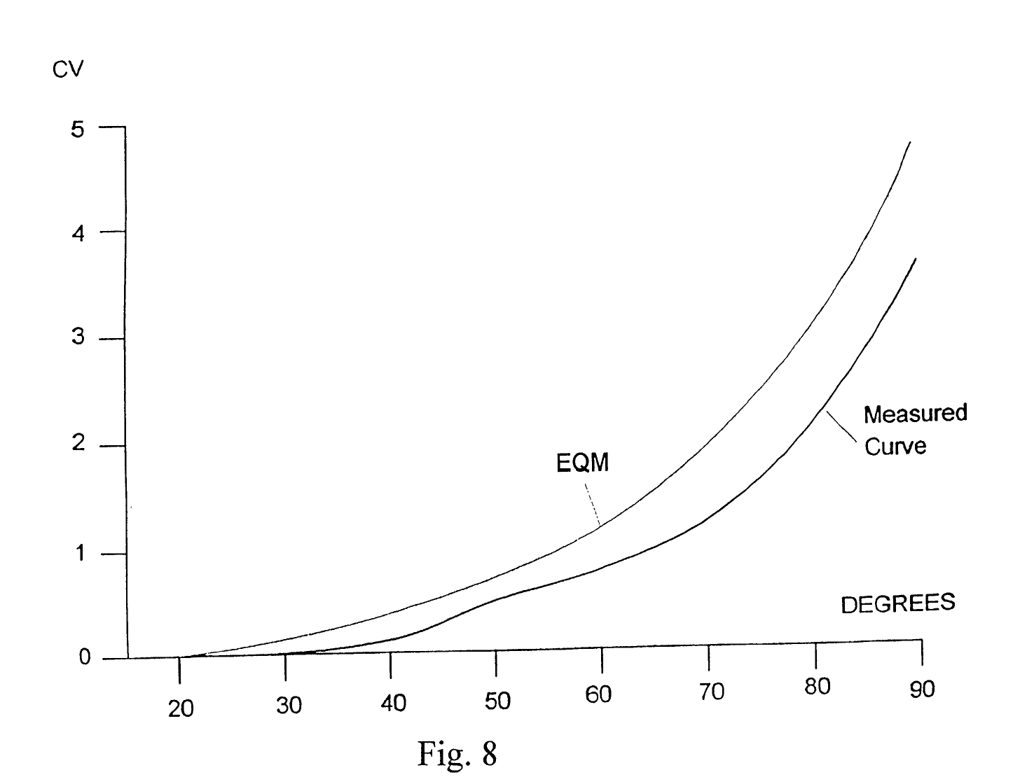

Control valve 10 has an effective cross-sectional area in which fluid flow generally escalates as valve 10 is opened, thereby preferably approaching equal percent characteristics. Curves EQ and EQM as shown in FIGS. 7-8 depict modified theoretical equal percent characteristics curves. CV represents the valve flow coefficient, and can generally be represented by the following equation:

$$CV = {Flow ( \frac{{P}_{1} - {P}_{2}}{d} )}^{- 1 / 2}$$

Where,

CV is the flow coefficient, which is representative of flow resistance;

P₁ is the upstream pressure in pounds per square inch;

P₂ is the downstream pressure in pounds per square inch;

Flow throughout this disclosure and in the above-referenced equation means the volumetric flow rate in gallons per minute; and

d is density, which is generally 1 gram/cc for water. FIG. 8 further shows a measured valve characteristics curve for a 3/4 inch valve 10, as compared to the modified theoretical equal percent characteristic curve EQM. By “equal percent characteristics” it is meant that an equal percentage change over the previous fluid flow for equal position changes of the moveable member are provided. By “modified”, it is meant that valve characteristics curves in FIGS. 7-8 have been modified so that flow equals zero when the valve 10 is closed. An equal percent characteristic is:

Q%=100e^{a(h/}100−1)

Where:

“Q %” is the fluid flow (typically in gallons per minute) in percent of the fluid flow of the fully open valve;

“a” is a constant that determines how pronounced the curvature is; and

“h” is the percentage opening of the valve.

If, for example, a=3.2 is selected, the fluid flow will be about 4% when valve 10 is closed (h/100=0). The “a” value can differ for different valve designs, but an a=3.2 is commonly used. This theoretical approximation does not accurately describe fluid flow because an a of 3.2 represents a resulting residual fluid flow which does not occur in practical application (i.e., the valves do not leak). There usually is a need for the valve to close completely. Therefore, the theoretical equal percent curve has to be slightly modified so zero flow is reached when the valve is fully closed, yet the flow gradually increases as the valve is fully opened. Preferably “a” ranges from 2 to 5 and more preferably, from 3 to 4.

Other representations of valve characteristics are:

$$q \% = \frac{100 Φ}{100 / h - 1 + Φ} q \% = \frac{100 ( {e}^{( bh / 100} - 1 )}{{e}^{b} - 1}$$

Where, q % is % flow; h is the value position, and b and φ, are typically selected to obtain 20% of the flow at 50% of the valve opening, but these values may vary.

Thus, a pragmatic approach is used when the valve 10 is designed. A valve 10 providing an essentially flow exponential curve that closely resembles the theoretical equal percent curves described above is chosen. A typical curve gives about 50% flow when the valve is 80% open and 20% flow when the valve 10 is 50% open. Of course, when fully open, the flow is 100% and when closed, the flow is 0%.

Valves 10 are preferably further provided with an even more steeply exponentially increasing effective cross-sectional areas 300 as the valve 10 is opened where the pressure drop across the valve 10 relative to its opened and closed position is relatively low. For the discussion above, it is assumed that the differential pressure, P₁-P₂, remains constant as the valve 10 is operated between open and closed. However, due to the rest of the hydronic system, the differential pressure tends to be lower when the valve 10 is open and higher when it is closed. Thus, the differential pressure across the valve 10 varies as the valve 10 is operated. The variation in differential pressure across the valve 10 between closed and opened valve position is expressed as a ratio “A” which is referred to as the “valve authority”. In addition to the effective cross-sectional area 300 of the valve 10, valve authority also effects the valve characteristic and in particular the shape of the valve characteristic curve in practical application. In other words, it is now appreciated that the effective cross-sectional area 300 of valve 10 must further be modified to reflect the effect of the pressure drop across the valve 10 relative to the system so as to effect stable control of the valve 10 by actuator 150, and accordingly the heating or cooling output of the system.

Valve authority is typically represented by the following equation:

$$A = \frac{. dp open valve}{. dp closed valve}$$

Where .dp is the differential pressure P₁-P₂. The larger the variation in the differential pressure, the smaller the valve authority (A) will be. Valve authority is typically less than 1.

If the valve authority is relatively low, the flow will no longer vary in accordance with the equal percent characteristics. It is therefore desirable to design systems in such a way that a high valve authority is accomplished. This is done by selecting a valve 10 with a CV value that is sufficiently large to supply the desired flow, but not any larger than required to provide sufficient fluid flow to the system.

Typically, valves 10 are oversized. In order to keep the distortion of the valve characteristic curve to an acceptable level, it is preferable that the valve authority is not less than A=0.5. It is important that the valve 10 is sized correctly, so the variation in differential pressure is not too large. The invention applies to all valves 10 whether sized correctly or oversized.

In order to compensate for an oversized valve 10 or a valve 10 having a valve authority that is undesirably low, a valve having a disk 100, 100′, 100″ or 100′″ or ball 30′ or contoured body 160, or a valve having a specially shaped valve chamber can be used which provides an exaggerated valve characteristic to compensate for the distortion due to valve authority. Such values 10 have even more exaggerated flared ends 230a and 230b or exponentially increasing cross-section area of open 110 the farther from apex 210.

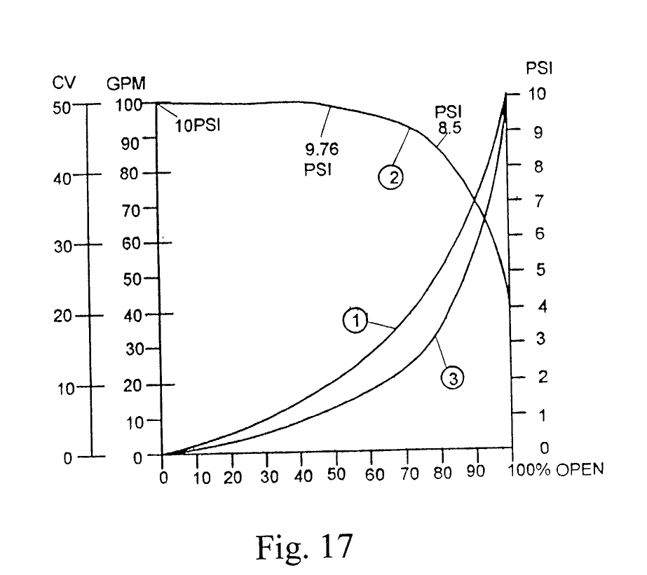

For example, FIG. 17 shows pressure drop (2), flow (1) and valve characteristic (3) for a valve 10 having a valve authority of 0.40. Curve 3 of FIG. 17 shows an example of an exaggerated valve characteristic curve. Thus, pressure drop shown in curve 2 of FIG. 17, varies relative to valve position. The resulting flow, curve 1 of FIG. 17, in gallons per minute, is shown as approximating equal percent characteristics or exponential or greater than linear curved which is desirable. It is understood that valves 10 having any CV values, pressures, and flow rates may be used as long as the relationship between heating or cooling output and valve position as disclosed herein is maintained.

It should be noted that the slope of curve 1 increases more dramatically than the typical equal percent characteristics. Thus, even though a valve 10 having a low valve authority or one that is oversized, when installed in a system, the pressure variation as the valve 10 is operated from opened to closed, distorts the flow characteristics of the valve and the flow characteristic curve, together with the exaggerated equal percent valve characteristics, results in an approximately equal percent flow characteristics.

It is often difficult to size a control valve having a high valve authority. Therefore, it is believed that a valve 10 providing an exaggerated valve characteristics curve that compensates for a valve authority A from about 0.4 to about 0.6 is a suitable compromise. The exaggerated curve required an exceptionally high rate of increase of the effective area as the fully open position is approached.

CV, or flow coefficient, as used herein and opening 110, 110′, 110″ and 110′″ are treated as proportional to one another. In other words, the other 110, 110′, 110″, and 110′″ exposed area typically doubles, as the CV value doubles. However, CV is not always proportional to opening 110, 110′, 110″, 110′″ because as opening 110, 110′, 110″ and 110′″ is exposed to fluid flow, as the movable member is rotated, the exposed area of opening 110, 110′, 110″ and 110′″ increases and the ratio between the exposed area and its perimeter changes. Also, as the movable member is repositioned, the effective cross-sectional area 300 is affected. All this contributes to discrepancies that make the relationship between the exposed area and the resulting CV valve not quite proportional. Still, the basic relationship between opening 110, 110′, 110″ and 110′″ relative to the position of the moveable member should be approximately equal percent characteristics, as described above. To determine the actual valve characteristics of the inventive valves, actual measurements of the CV value at different positions of the moveable member, as shown in FIG. 8 are easily measured, and would be know to those skilled in the art. While this disclosure refers to valves 10 used to control the flow of water in heating or cooling systems, it is understood that the invention disclosed herein will be useful in any application where modified flow capacity and/or flow characteristics and stable control of heating or cooling output are desired.

The above said is not only applicable to valves 10 having approximately equal percent valve characteristics, but can be applied to any valve 10 when it is desired to have valve characteristics exhibiting a high rate of increase in the cross-sectional area of the fluid flow passageway at the end of the movement of the ball or plug when the valve is fully opened.

Although the invention has been described with reference to a particular arrangement of parts, features and the like, these are not intended to exhaust all possible arrangements or features, and indeed many other possible arrangements or features, and indeed many other modifications and variations will be ascertainable to those of skill in the art.

What is claimed is:

1. A device for controlling fluid flow in a pipe, said device having a generally curved perimeter and being positioned substantially transverse to the flow of fluid, comprising:
upper and lower portions extending from an apex adjacent to said perimeter and terminating at ends opposed to the apex to define an opening having a flared shape for allowing fluid to flow therethrough.

2. The device according to claim 1 further comprising a 90° rotatable ball or plug having a hole therethrough which communicates with the opening of said device to provide approximately greater than linear characteristics.

3. The device according to claim 1 wherein at least one of the upper and lower portions further flare outward and then back toward the apex so as to define a point of inflection.

4. The device according to claim 2 wherein the fluid flow exponentially increases as said ball or plug approaches its fully opened position.

5. The device according to claim 2 further comprising a cover.

6. A valve having a casing defining a valve chamber for controlling fluid flow through a fluid flow passageway, comprising at least one device according to claim 1 disposed in the chamber.

7. The valve according to claim 6 further comprising a plug or ball disposed in the chamber, said ball or plug having a hole therethrough.

8. The valve according to claim 6 wherein said device is disposed in the hole and communicates with the fluid flow passageway as said ball or plug is opened and closed to provide approximately greater than linear characteristics.

9. The valve according to claim 8 wherein the fluid flow exponentially increases as said ball or plug approaches its fully opened position.

10. The valve according to claim 9 wherein the communication approaches equal percent characteristics.

11. The valve according to claim 7 wherein said device is integral with the valve casing.

12. The valve according to claim 7 wherein said device is a disk and is disposed adjacent to said plug or ball so that it rests tightly on or very close to the ball or plug.

13. The valve according to claim 7 wherein said device is a contoured body disposed in the hole of the ball or plug.

14. The valve according to claim 7 wherein said device further comprises a cover.

15. A valve having a casing defining a valve chamber and a ball or plug having a hole for controlling fluid flow through a fluid flow passageway having an effective cross-sectional area, comprising at least one device according to claim 3 disposed in the chamber.

16. A method for controlling the heating or cooling output of a system, comprising the step of:
operating the valve according to claim 15.

17. The method according to claim 16 wherein the valve has at least two ports and a shaft for controlling the opening or closing of the valve, one port having a coil or other heat transfer device connected thereto, so that incremental movements in the shaft position produce a heating or cooling output which is substantially proportional to the shaft movement.

18. The method according to claim 16 wherein the effective cross-sectional area increases exponentially as the ball or plug approaches its fully opened position.

19. The method according to claim 17 wherein the fluid flow has a high rate of increase as the ball or plug approaches its fully opened position.

20. The method according to claim 16 wherein the device is a disk disposed adjacent to and resting tightly or very closely on the ball or plug.

21. The method according to claim 16 wherein the device is a contoured body disposed in the hole of the plug or ball.

22. The method according to claim 16 wherein the device is integral with the valve casing.

23. A valve for controlling fluid flow through a fluid flow passageway, said valve having a shaft for controlling the position of the valve, comprising:
at least one device positioned transverse to the flow or fluid, and having an opening with a cross-sectional area that approximates e^{a}(h/100−1), where a is between about 2 and 5, and h is the valve shaft position, but modified so that the cross-sectional area is zero, when h is zero.

24. The valve according to claim 23, wherein a is between about 3 and 4.

25. The valve according to claim 24, wherein a is approximately 3.2.

26. The valve according to claim 15 wherein said device provides a valve characteristic which approximates that of the measured curved of FIG. 8.

27. The valve according to claim 15 wherein said device provides a valve characteristic which is quadratic.

28. The valve according to claim 15 wherein said device provides a valve characteristic which is approximately equal percent.

29. A valve for controlling fluid flow in a pipe, said valve providing a valve authority and a flow characteristic, comprising:
at least one device according to claim 3, wherein with a valve authority which is less than about 1 which so as to provide approximate+ly equal percent flow characteristics.

30. The valve according to claim 29 wherein the valve authority is about 0.3 to about 0.8.
